(19) United States
(12) Patent Application Publication
(10) Pub. No.: US 2015/0034780 A1
(43) Pub. Date: Feb. 5, 2015

(54) ADJUSTABLE STAND FOR TELEVISIONS AND MONITORS

(71) Applicant: Multiplatform, LLC, Kent, OH (US)

(72) Inventor: ROBERT PETRY, Kent, OH (US)

(21) Appl. No.: 14/449,607

(22) Filed: Aug. 1, 2014

Related U.S. Application Data
(60) Provisional application No. 61/861,508, filed on Aug. 2, 2013.

(51) Int. Cl. F16M 11/04

(52) U.S. Cl. CPC F16M 11/043
USPC 248/160; 29/428; 29/525.01

(57) ABSTRACT

This disclosure is of a stand including a base, a fixed arm, wherein the fixed arm is operatively connected to the base, and an extendable arm, wherein the extendable arm is adjustably attached to the fixed arm, wherein the extendable arm has a first end and a second end, wherein the first end is connected to the fixed arm, wherein the fixed arm and the extendable arm have a curvature κ.

### I. BACKGROUND

A. Field

This application claims priority to U.S. Ser. No. 61/861,508, filed Aug. 2, 2013. This invention pertains to the art of appliance stands, and more specifically, to adjustable stands for televisions and monitors.

B. Description of the Related Art

Currently, televisions and monitors that are intended to be adjustable are either placed on wheeled carts or mounted to a wall. Sometimes the wall-mounted televisions and monitors have a telescoping arm that allows for some level of movement.

Televisions used in hospitals are typically mounted on the wall, and frequently are not adjustable. Or, if they are adjustable, they can swivel to face different portions of the room.

Some televisions and monitors are mounted on arms that allow some horizontal movement. However, being able to have a television or monitor adjustable over a bed or desk is difficult to construct.

Cauchy defined the center of curvature C as the intersection point of two infinitely close normals to the curve, the radius of curvature as the distance from the point to C, and the curvature itself as the inverse of the radius of curvature. Let C be a plane curve (the precise technical assumptions are given below). The curvature of C at a point is a measure of how sensitive its tangent line is to moving the point to other nearby points. There are a number of equivalent ways that this idea can be made precise.

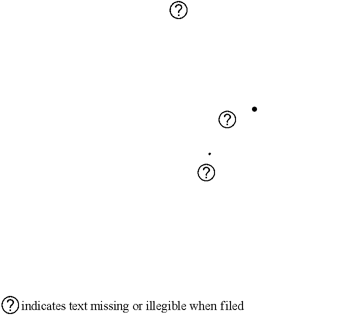

One way is geometrical. The curvature of a circle of radius r should be large if r is small and small if r is large. Thus the curvature of a circle is defined to be the reciprocal of the radius: κ=1/r.

Given any curve C and a point P on it, there is a unique circle or line which most closely approximates the curve near P, the osculating circle at P. The curvature of C at P is then defined to be the curvature of that circle or line. The radius of curvature is defined as the reciprocal of the curvature. Another way to understand the curvature is physical. Suppose that a particle moves along the curve with unit speed. Taking the time s as the parameter for C, this provides a natural parameterization for the curve. The unit tangent vector T (which is also the velocity vector, since the particle is moving with unit speed) also depends on time. The curvature is then the magnitude of the rate of change of T. Symbolically,

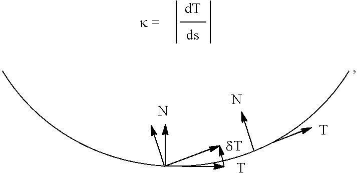

The T and N vectors at two points on a plane curve, a translated version of the second frame (dotted), and the change in T: δT. δs is the distance between the points. In the limit dT/ds will be in the direction N and the curvature describes the speed of rotation of the frame.

This is the magnitude of the acceleration of the particle and the vector dT/ds is the acceleration vector. Geometrically, the curvature κ measures how fast the unit tangent vector to the curve rotates. If a curve keeps close to the same direction, the unit tangent vector changes very little and the curvature is small; where the curve undergoes a tight turn, the curvature is large. These two approaches to the curvature are related geometrically by the following observation. In the first definition, the curvature of a circle is equal to the ratio of the angle of an arc to its length. Likewise, the curvature of a plane curve at any point is the limiting ratio of dθ, an infinitesimal angle (in radians) between tangents to that curve at the ends of an infinitesimal segment of the curve, to the length of that segment ds, i.e., dθ/ds. If the tangents at the ends of the segment are represented by unit vectors, it is easy to show that in this limit, the magnitude of the difference vector is equal to dθ, which leads to the given expression in the second definition of curvature.

Therefore, a need exists for an adjustable stand for a television or monitor that allows for ease of use and removable over beds and other items of furniture.

### II. SUMMARY

In accordance with one aspect of the present invention, an adjustable stand provides for a curved, telescoping arm to hold the television or monitor.

In accordance with another aspect of the present invention, the curvature and angle of the telescoping arm can be adjusted as desired.

In accordance with another aspect of the present invention, a stand includes a base, a fixed arm, wherein the fixed arm is operatively connected to the base, and an extendable arm, wherein the extendable arm is adjustably attached to the fixed arm, wherein the extendable arm has a first end and a second end, wherein the first end is connected to the fixed arm, wherein the fixed arm and the extendable arm have a curvature κ.

In accordance with another aspect of the present invention, the curvature κ is between approximately 0.0001 and approximately 0.1.

In accordance with another aspect of the present invention, the extendable arm is telescopically, adjustably connected to the fixed arm.

In accordance with another aspect of the present invention, the stand further includes a connecting bracket, the connecting bracket operatively attached to the second end of the extendable arm.

In accordance with another aspect of the present invention, the stand further includes a pivotable attachment, wherein the pivotable attachment connects the connecting bracket to the second end of the extendable arm, and a bracket plate, wherein the bracket plate is operatively connected to the connecting bracket.

In accordance with another aspect of the present invention, the stand further includes a support, wherein the support fixedly attaches the connecting portion to the base, and an adjustment knob, the adjustment knob operatively connected to the fixed arm, wherein the adjustment knob adjusts the telescoping length of the extendable arm.

In accordance with another aspect of the present invention, an associated electronic monitor is fixedly attached to the bracket plate.

In accordance with another aspect of the present invention, the associated electronic monitor is a television or computer monitor.

In accordance with another aspect of the present invention, the base has a top side and a bottom side, wherein the connecting portion is connected to the top side, and wheels are attached to the bottom side.

In accordance with another aspect of the present invention, the fixed arm is adjustably connected to the base.

In accordance with another aspect of the present invention, the curvature κ is between approximately 0.001 and approximately 0.1.

In accordance with another aspect of the present invention, the curvature κ is between approximately 0.01 and approximately 0.1.

In accordance with another aspect of the present invention, a method for mounting a monitor includes attaching a fixed arm to a base, operatively attaching an extendable arm to the fixed arm, wherein the fixed arm and the extendable arm have a curvature κ, wherein the extendable arm has a first end and a second end, and attaching the monitor to the second end of the extendable arm.

In accordance with another aspect of the present invention, the method further includes attaching a connecting bracket to the second end of the extendable arm, wherein the monitor is attached to the connecting bracket.

In accordance with another aspect of the present invention, the method further includes connecting the connecting bracket to the second end of the extendable arm with a pivotable attachment, and attaching a bracket plate to the connecting bracket.

In accordance with another aspect of the present invention, the method further includes attaching a support to the connecting portion and to the base, and using an adjustment knob to adjust the telescoping length of the extendable arm, wherein the adjustment knob is operatively connected to the fixed arm.

In accordance with another aspect of the present invention, the base has a top side and a bottom side, wherein the connecting portion is connected to the top side, and wheels are attached to the bottom side.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a bed and the stand;

FIG. 2A is a side view of the stand in a retracted position;

FIG. 2B is a side view of the stand in an extended position;

FIG. 3A is a side view of the stand;

FIG. 3B is a rear view of the stand;

FIG. 3C is a side view of the stand;

FIG. 4A is a perspective view of an adjustable bracket;

FIG. 4B is a perspective view of an adjustable bracket;

FIG. 5A is a side view of the arm in an extended position;

FIG. 5B is a perspective view of the adjustable bracket attached to the monitor;

FIG. 6A is a perspective view of the adjustable bracket and extended arm;

FIG. 6B is a side view of the attachment of the adjustable bracket;

FIG. 7A is a side view of the stand in an extended position over a bed;

FIG. 7B is a rear view of the stand in an extended position over a bed;

FIG. 8A is a perspective rear view of the stand in a retracted position;

FIG. 8B is a perspective front view of the stand in a retracted position;

FIG. 9A is a side view of the stand in an angled retracted position;

FIG. 9B is a side view of the stand in a retracted position;

FIG. 9C is a side view of the stand in an extended position;

FIG. 10A is a perspective rear view of the stand over a desk;

FIG. 10B is a perspective front view of the stand over a desk;

FIG. 11 is a side view of the stand as a kiosk;

FIG. 12A is a perspective view of the stand in a surgical room;

FIG. 12B is a side view of the stand in a surgical room;

FIG. 12C is an exploded perspective view of the stand in a surgical room;

FIG. 13A is a side view of the stand with wheels;

FIG. 13B is a rear view of the stand with wheels; and,

FIG. 13C is a side view of the stand with wheels.

### IV. DETAILED DESCRIPTION

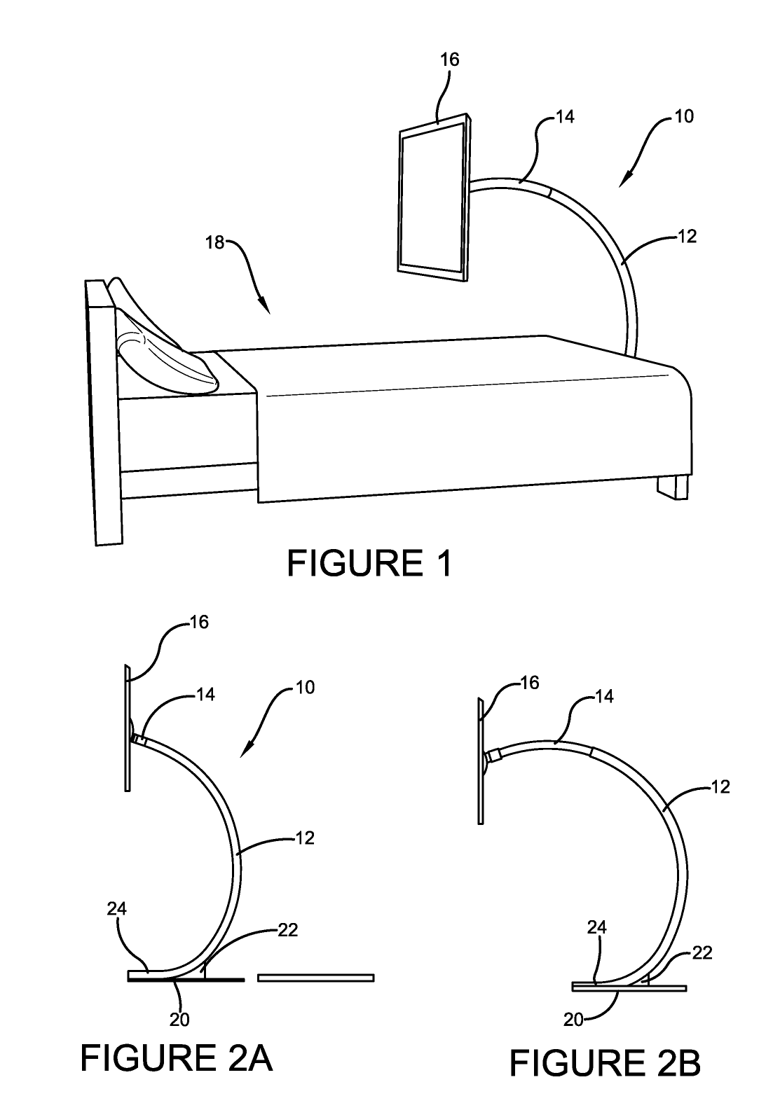

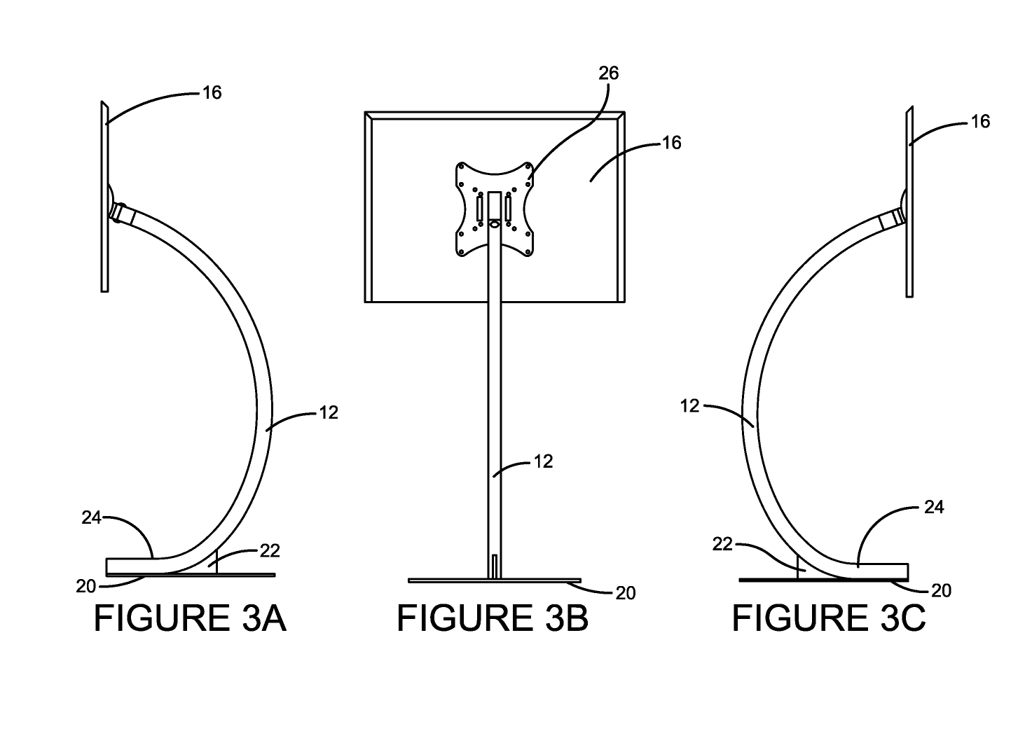

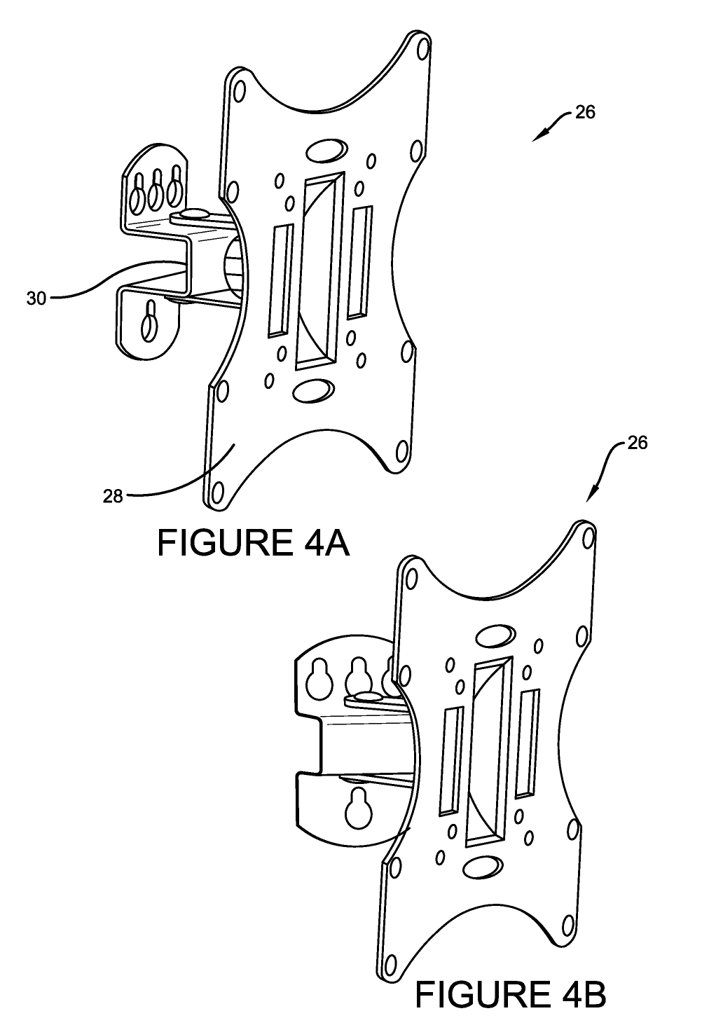

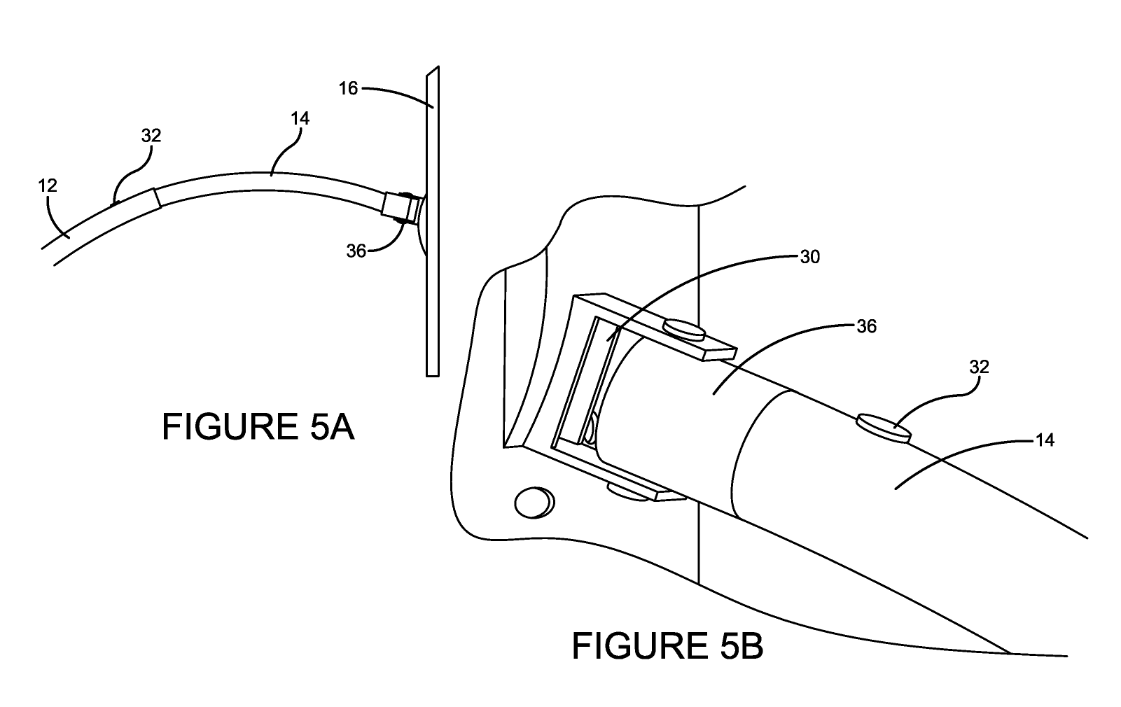

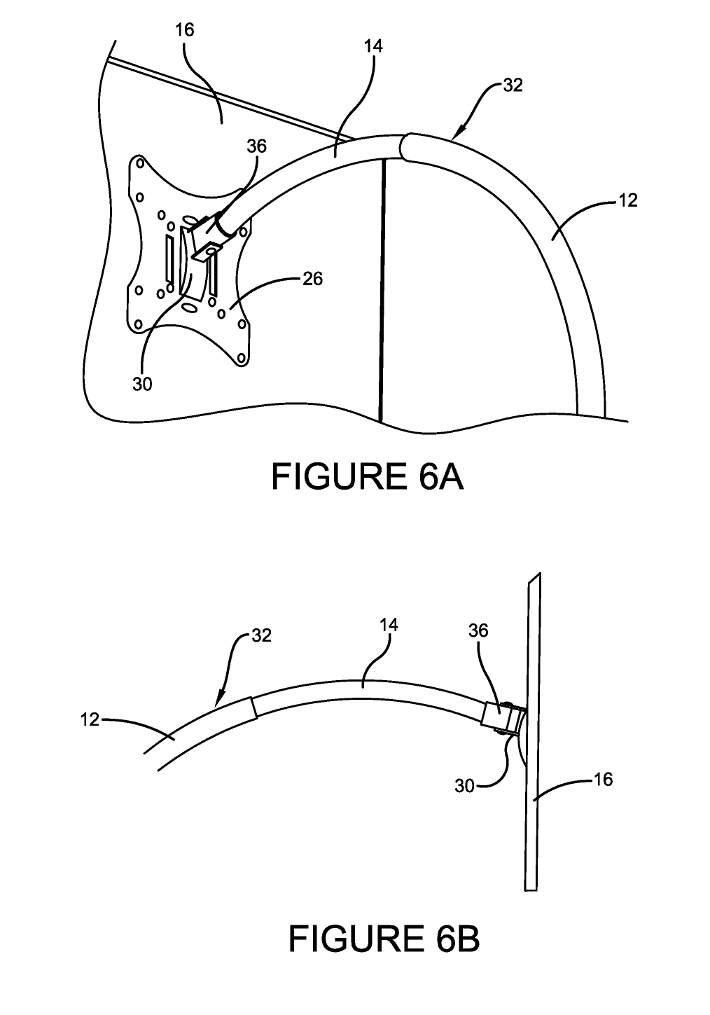

Referring now to the drawings wherein the showings are for purposes of illustrating embodiments of the invention only and not for purposes of limiting the same, and wherein like reference numerals are understood to refer to like components, FIGS. 1-6B show a bed 18, with an adjustable stand 10, having a fixed arm 12, an extendable arm 14, a base 20, a support 22, a connecting portion 24, a bracket 26, a bracket plate 28, a pivotable attachment 30, an adjustment knob 32, and an end piece 36. In this embodiment, the connecting portion 24 is substantially flat, and is fixedly attached to the base 20. The support 22 connects the stand 10 to the base 20 as the connecting portion 24 becomes the beginning of the curved portion of the stand 10. The fixed arm 12 extends in a curving manner upwardly from the connecting portion 24, and is adjustably attached to the extendable arm 14. The extendable arm 14 is connected to the fixed arm 12 in such a manner that the extendable arm can extend outwardly from the fixed arm 12. The extendable arm 14 has a curvature substantially similar to the fixed arm 12. It is to be understood that the curvature κ of the arms 12, 14, with radius r measured in inches, is between approximately 0.0001 and approximately 0.1. The radius r represents the radius of the circle that would be created if the curvature of the arms 12, 14 were continued all the way around to the connecting portion 24. For example, in FIG. 2A, if arms 12, 14 had a radius of thirty (30) inches, the circumference would be 188.5 inches, and the arc represented by the arms 12, 14 would be 94.25 inches. The curvature κ would be 1/30, which is 0.033. The higher the arms 12, 14 extend in the air, the larger the radius would be, and the lower the curvature would be.

With reference now to FIGS. 1-6B, the fixed arm 14 ends with an end piece 36. Attached to the end piece 36 is a pivotable attachment 30, which is attached to the bracket plate 28. The pivotable attachment 30 allows the monitor to be manipulated in a horizontal arc around the arms 12, 14. Typically, the pivotable attachment 30 allows for a rotation of ninety degrees in either direction. The pivotable attachment 30 could also be configured to allow for rotation in a vertical arc, with a rotation of ninety degrees in either direction. The bracket plate 28 attaches to the monitor or television 16, and allows movement of the monitor or television 16, as desired. It is also to be understood that the monitor or television 16 could be fixedly attached to the stand, and it is also to be understood that the stand 10 could simply have a fixed arm 12 and no extendable arm 14. The adjustment knob 32 allows for the extendable arm 14 to be held in place once it has been extended, thereby preventing the extendable arm 14 from retracting back into the fixed arm 12. The adjustment knob 32 could simply be a handle with a threaded screw that would be used to hold the extendable arm 14 in place. Or, instead of a knob 32, a series of spring-loaded pins along the length of the extendable arm 14 could be used to hold the arm 14 in place. It is to be understood, however, that any means of holding the extendable arm 14 in place, while allow the extension and refraction of the arm 14, can be used.

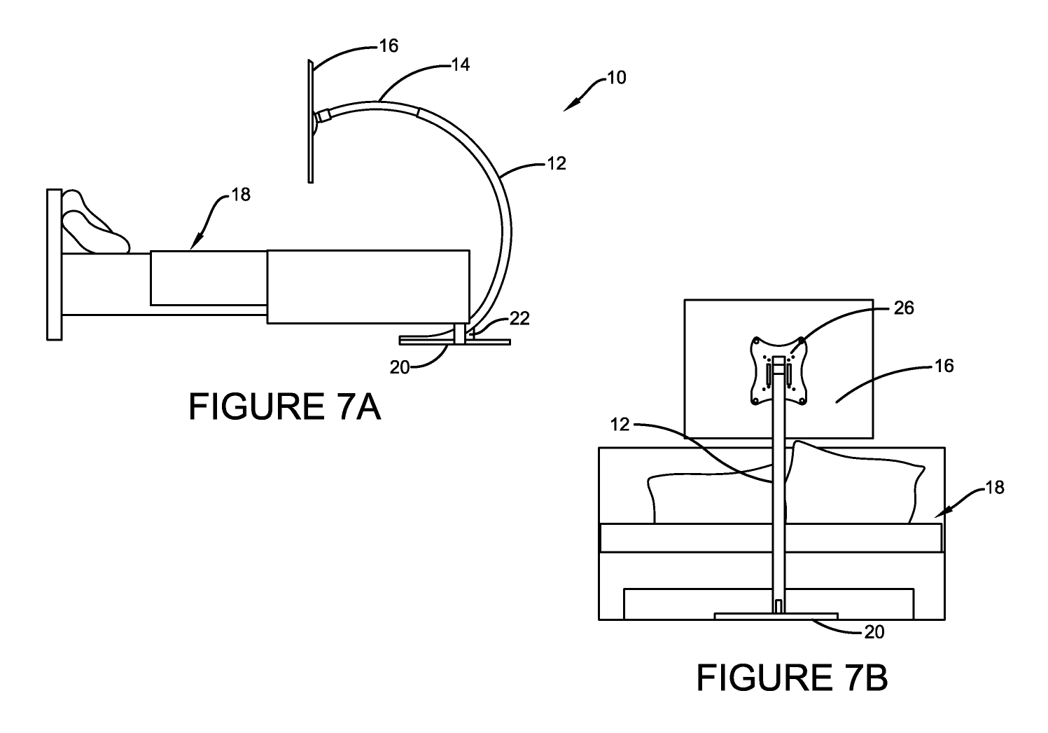

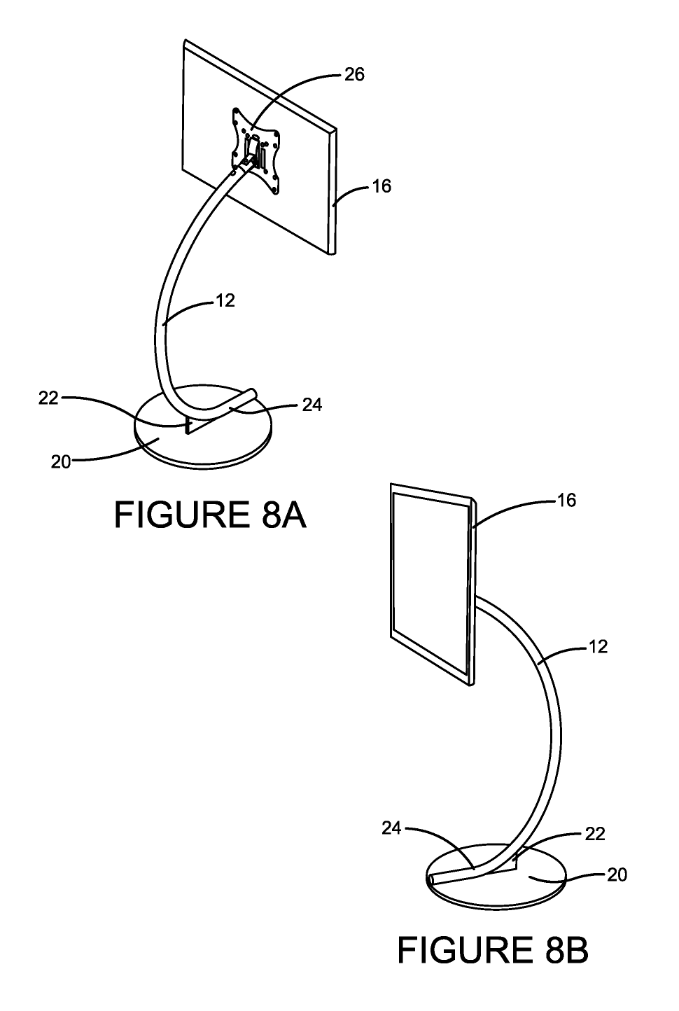

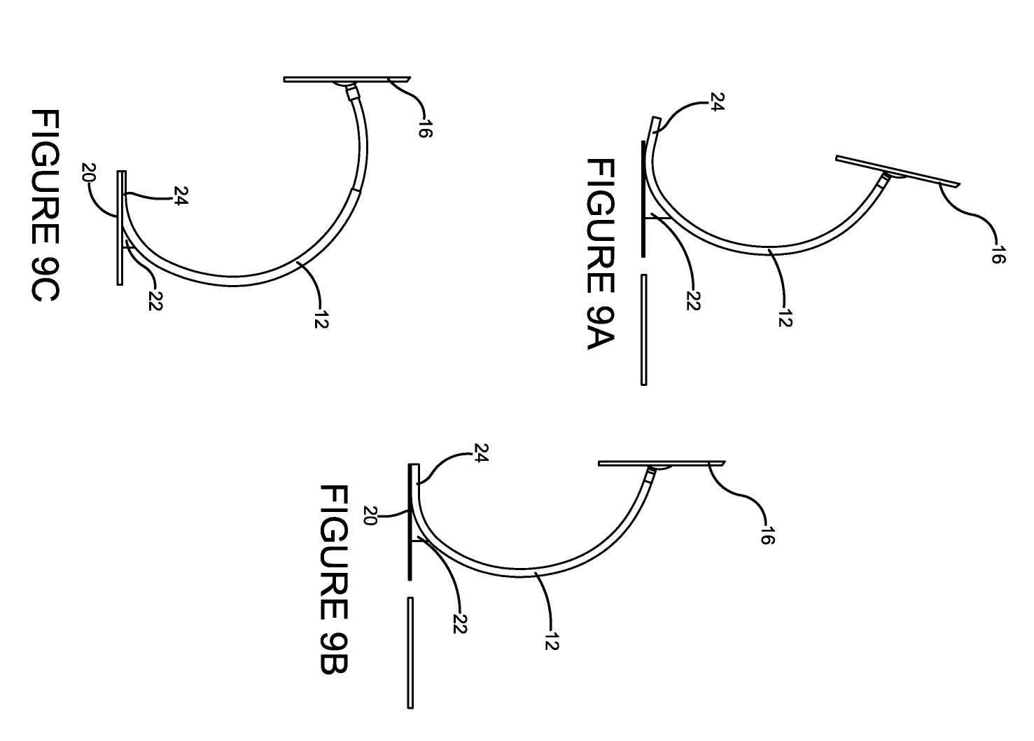

With reference now to FIGS. 7A-9C, the stand 10 is shown in various positions and with a bed 18. In FIG. 7A, the stand 10 is shown extended such that the monitor or television 16 extends about halfway across the bed 18, while the base 20 is located under the end of the bed 18. FIGS. 9A-9C show the stand 10 in retracted and extended positions, as well as in a rotated position. FIG. 9A shows an embodiment wherein the connecting portion 24 is not fixedly attached to the base 20, but can be rotatably connected to the base 20. FIG. 9A also shows an embodiment wherein the connecting portion 24 is not substantially flush against the top of the base 20. In FIG. 9A, the connecting portion 24 could be movably attached to the base 20, such that the connecting portion 24 can be slid along the base, thereby adjusting the stand 10.

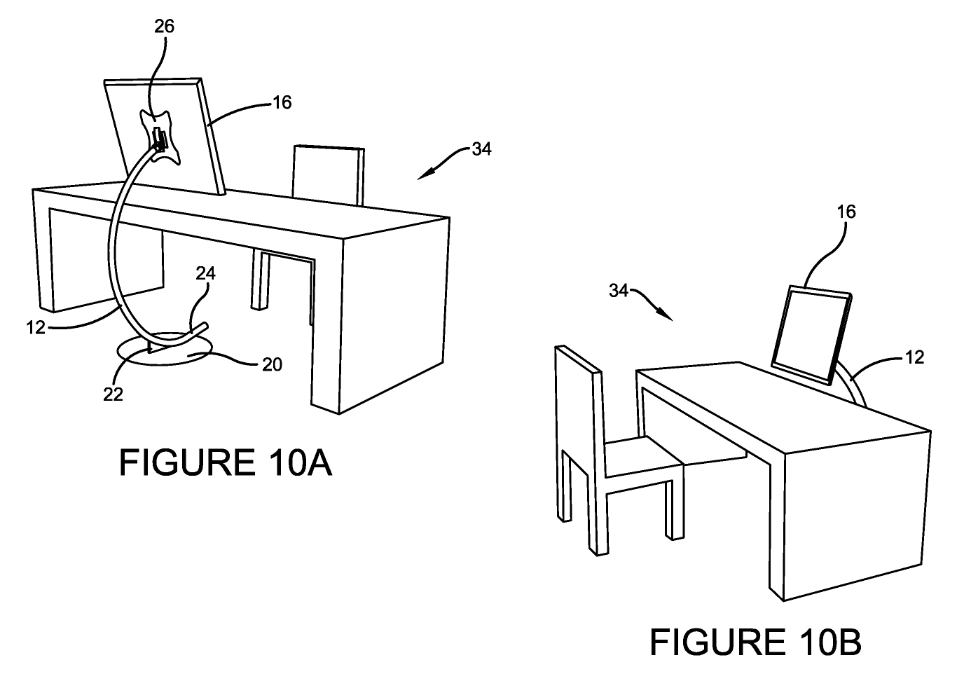

With reference now to FIGS. 10A and 10B, another embodiment is shown, wherein the stand 10 is used with a desk 34. In this embodiment, the base 20 is under the desk 34, and the arms 12, 14 extend around the desk and hold the monitor or television 16 above the desk 34.

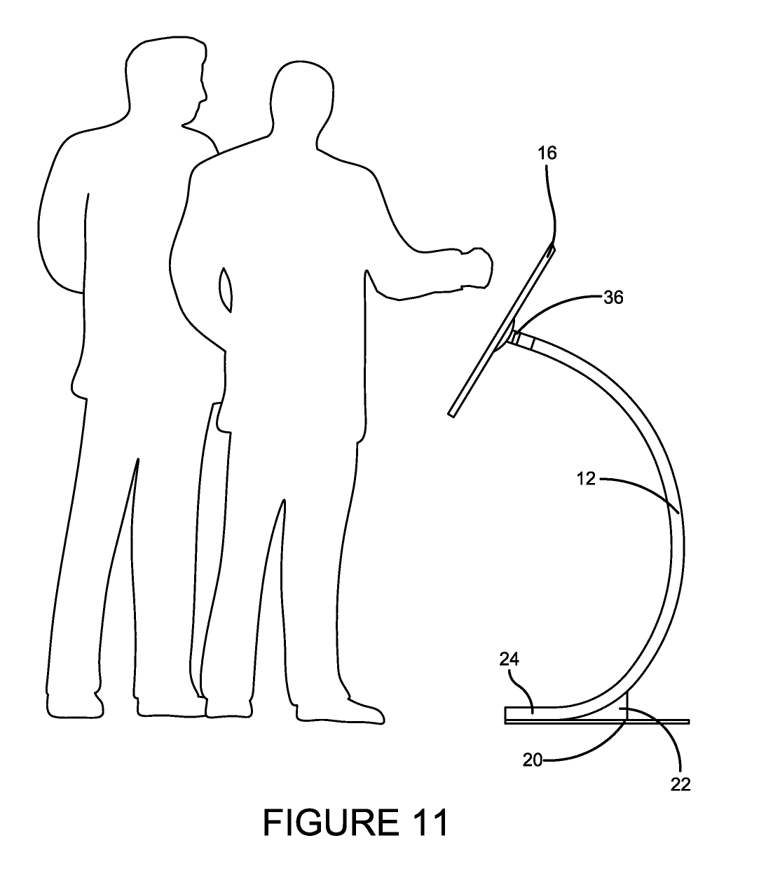

With reference now to FIG. 11, another embodiment shows the stand 10 as a stand-alone kiosk. The base 20 rests on the floor and the arms 12, 14 extend upwardly to present the monitor or television 16 for use. The bracket 36 allows the monitor or television 16 to be adjusted by the user.

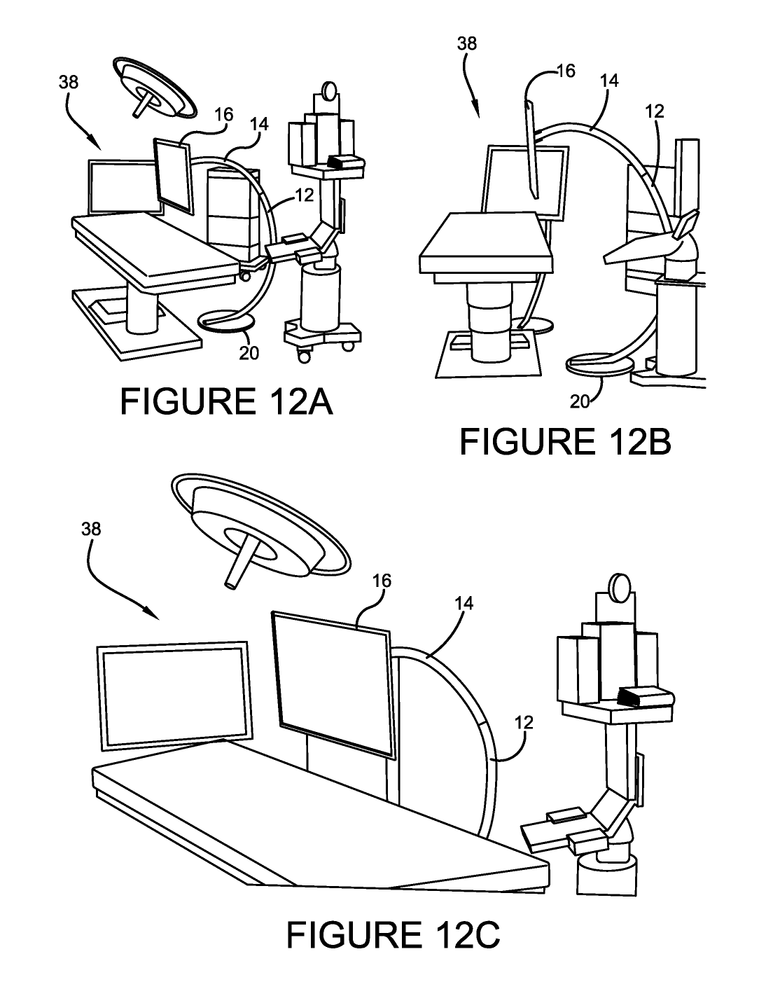

With reference now to FIGS. 12A-12C, another embodiment is shown, wherein the stand 10 is used with a surgical table 38. The operation of the stand with the operation table 38 is the same as with the previous embodiments.

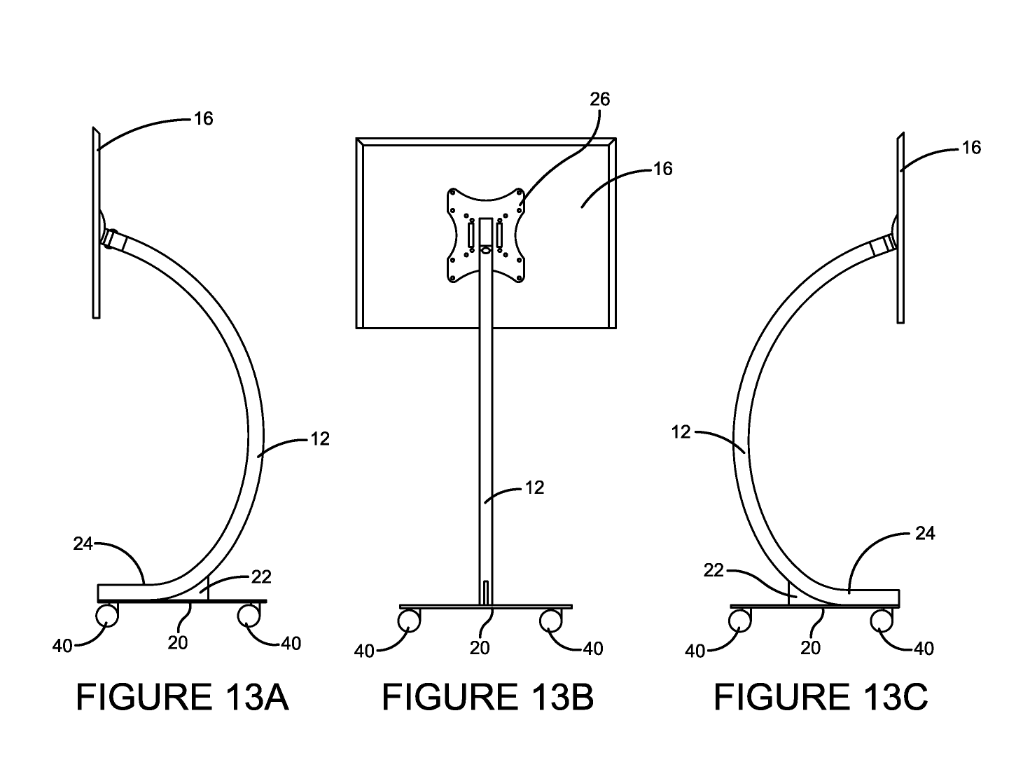

With reference now to FIGS. 13A-13C, another embodiment is shown, wherein the stand 10 is shown so that the stand 10 is mobile. In this embodiment, wheels 40 are shown attached to the base 20, so that the stand 10 can be easily moved around as desired. The wheels 40 can be in either a locked or unlocked position (not shown). It is to be understood that although wheels 40 are shown in the FIGURES, any means of making the stand 10 mobile could be used, as long as chosen using sound engineering judgment.

With reference to FIGS. 1-13C, the monitor 16 can have a cord (not shown), and the cord can be threaded down the length of the arms 12, 14 and out through the base 20. Another embodiment can be that the arms 12, 14 could have an exit hole for the cord to pass through.

Although the description above contains much specificity, these should not be construed as limiting the scope of the invention but as merely providing illustrations of this invention. Various other embodiments and ramifications are possible within its scope.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplifications presented hereinabove. Rather, what is intended to be covered is within the spirit and scope of the appended claims.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The invention has been described with reference to several embodiments. Obviously, modifications and alterations will occur to others upon a reading and understanding of the specification. It is intended by applicant to include all such modifications and alterations insofar as they come within the scope of the appended claims or the equivalents thereof

Having thus described the invention, it is now claimed:

I/we claim:

1. A stand comprising:
a base;
a fixed arm, wherein the fixed arm is operatively connected to the base; and,
an extendable arm, wherein the extendable arm is adjustably attached to the fixed arm, wherein the extendable arm has a first end and a second end, wherein the first end is connected to the fixed arm, wherein the fixed arm and the extendable arm have a curvature κ.

2. The stand of claim 1, wherein the curvature κ is between approximately 0.0001 and approximately 0.1.

3. The stand of claim 1, wherein the extendable arm is telescopically, adjustably connected to the fixed arm.

4. The stand of claim 1, wherein the stand further comprises:
a connecting bracket, the connecting bracket operatively attached to the second end of the extendable arm.

5. The stand of claim 4, wherein the stand further comprises:
a pivotable attachment, wherein the pivotable attachment connects the connecting bracket to the second end of the extendable arm; and,
a bracket plate, wherein the bracket plate is operatively connected to the connecting bracket.

6. The stand of claim 5, wherein the stand further comprises:
a support, wherein the support fixedly attaches the connecting portion to the base; and,
an adjustment knob, the adjustment knob operatively connected to the fixed arm, wherein the adjustment knob adjusts the telescoping length of the extendable arm.

7. The stand of claim 6, wherein an associated electronic monitor is fixedly attached to the bracket plate.

8. The stand of claim 7, wherein the associated electronic monitor is a television or computer monitor.

9. The stand of claim 1, wherein the base has a top side and a bottom side, wherein the connecting portion is connected to the top side, and wheels are attached to the bottom side.

10. The stand of claim 1, wherein the fixed arm is adjustably connected to the base.

11. The stand of claim 1, wherein the curvature κ is between approximately 0.001 and approximately 0.1.

12. The stand of claim 1, wherein the curvature κ is between approximately 0.01 and approximately 0.1.

13. A method for mounting a monitor, the method comprising the steps of:
attaching a fixed arm to a base;
operatively attaching an extendable arm to the fixed arm, wherein the fixed arm and the extendable arm have a curvature κ, wherein the extendable arm has a first end and a second end; and,
attaching the monitor to the second end of the extendable arm.

14. The method of claim 13, wherein the curvature κ is between approximately 0.0001 and approximately 0.1.

15. The method of claim 13, wherein the extendable arm is telescopically, adjustably connected to the fixed arm.

16. The method of claim 14, wherein the method further comprises:
attaching a connecting bracket to the second end of the extendable arm, wherein the monitor is attached to the connecting bracket.

17. The method of claim 16, wherein the method further comprises:
connecting the connecting bracket to the second end of the extendable arm with a pivotable attachment; and,
attaching a bracket plate to the connecting bracket.

18. The method of claim 17, wherein the method further comprises:
attaching a support to the connecting portion and to the base; and,
using an adjustment knob to adjust the telescoping length of the extendable arm, wherein the adjustment knob is operatively connected to the fixed arm.

19. The method of claim 13, wherein the base has a top side and a bottom side, wherein the connecting portion is connected to the top side, and wheels are attached to the bottom side.
